(19) United States
(12) Patent Application Publication
(10) Pub. No.: US 2010/0326248 A1
(43) Pub. Date: Dec. 30, 2010

(54) Telescoping handle for tools having circular locking indents

(76) Inventor: Greg Owoc, Greemville, SC (US)

Correspondence Address: GREG OWOC, 2435 E. NORTH ST., BOX 130, Greenville, SC, 29615, US

(21) Appl. No.: 12/495,113

(22) Filed: Jun. 30, 2009

(51) Int. Cl. B25B 23/16; B25G 1/04

(52) U.S. Cl. 81/177.2

(57) ABSTRACT

A tool having a telescoping handle including a main shank and an outer sleeve complementary shaped to receive the main shank therein, the main shank includes indents formed in a circular pattern around the outer circumferential surface of the main shank a locking collar is provided to cause bearing members to selectively engage the circular indents formed on the main shank in order to selectively lock the telescoping handle in the unextended and extended positions while preventing the telescoping handle from rotating around the main shank.

### FIELD OF THE INVENTION

The present invention relates generally to the field of telescoping handles and more particularly to the field of tools having telescoping handles.

### BACKGROUND

Tools that are used to apply torque and leverage to work pieces, such as nuts, bolts, are typically designed to have a constant length handle, and therefore to apply the same amount of torque or leverage to the work piece, regardless of the size of the work piece, this limitation is especially prevalent in the use of tools having standard or non-standard sized socket heads such as ¼″, ⅜″, ½″, ¾″, 1,′ or greater, which allow a user to use numerous different sized sockets to tighten or loosen different sized work pieces, this limitation also arises in the use of adjustable head wrenches, such as pipe wrenches and crescent wrenches where a user is using the same wrench to apply torque or leverage to different sized work pieces. The constant length handle does not allow for greater or lesser torque to be applied when the tool is used to tighten or loosen larger or smaller work pieces.

The limitation of a constant length handle also arises in other situations where it is desirable to be able to apply different amounts of torque to a work piece, such as when the work piece has been frozen in place due to corrosion. Further, a tool with a long, stationary handle, which provides more available leverage or torque than a tool with a smaller handle, may not fit into a commonly available toolbox or storage compartment in a vehicle with limited storage space such as a military tank. A tool with a telescoping handle provides the option of stowing the tool into smaller containers or compartments.

For these and other reasons it is desirable to provide a telescoping handle for use with tools, for example, ratchets, wrenches, breaker bars, adjustable punchers crescent wrenches, open end wrenches, box wrenches, and pipe wrenches.

### SUMMARY

In order to provide a handle for use with tools that is capable of applying different amounts of torque or leverage to the same or different work pieces, an embodiment of an inventive telescoping handle is provided. In the main embodiment, a tool having a telescoping handle comprises a main shank, an outer sleeve having distal and proximal ends, may be mounted telescopically to the main shank. The sleeve may include an outer circumferential surface having two axially spaced dismal and proximal circumferential grooves located near the distal end for retaining corresponding snap rings. The outer circumferential surface may have a uniform outer circumference outside the distal and proximal grooves, the outer sleeve includes a bore defined by an inner circumferential surface and extending from the distal end of the sleeve. The bore may be sized and configured to matingly engage the outer circumferential surface of the shank.

The outer sleeve may further include at least four clearance holes, located between the distal and proximal grooves, and extending through the outer sleeve from the outer circumferential surface, to the inner circumferential surface. Bearing members may be positioned within the clearance holes for selectively engaging the locking structure. A spring member may be positioned on the outer sleeve between the distal and proximal grooves such that the proximal end of the spring member engages the proximal snap ring. An annular locking collar may be positioned along the outer sleeve between the distal and proximal grooves. The collar may include distal and proximal inner circumferential surfaces separated at the distal and proximal right angles by a circumferential bearing member engaging surface that is configured to selectively engage the bearing members, thus the distal right angle portion may define a distal snap ring engaging surface for selectively engaging the distal snap ring and the proximal right angle portion may define a spring member engaging surface for engaging the spring member. In this manner the spring member may be retained in the space defined between the proximal snap ring, the outer circumferential surface of the sleeve, the spring member engaging surface, and the proximal inner circumferential surface of the annular locking collar. In use, the annular locking collar may be axially displaceable such that when the distal snap ring engaging surface of the annular locking collar is in engagement with the distal snap ring, the bearing member engaging surface engages the bearing members in order to lock the bearing members in engagement with the locking structure to prevent extension, shortening, and rotation of the telescoping handle and such that when the bearing member engaging surface of the annular locking collar does not engage the bearing members, the telescoping handle may be extended or shortened.

### BRIEF DESCRIPTION OF THE DRAWINGS

FIG. 1A is a side elevation view of an embodiment of a telescoping handle, in combination with a tool head, in a locked and unextended position.

FIG. 1B is a side elevation view of the embodiment of FIG. 1A in an extended position.

FIG. 1C is a bottom view of the embodiment of FIG. 1A in partial assembly.

FIG. 1D is an end view of the outer sleeve of the embodiment of FIG. 1A

FIG. 1E is an exploded view of the annular locking collar and the outer sleeve of the embodiment of FIG. 1A.

FIG. 1F is a partial cross-sectional view of the embodiment of FIG. 1A showing the telescoping handle in an unlocked position.

FIG. 2A is a cut-away view of the outer sleeve showing a machined tapered groove at the distal end and inner circumferential surface of the outer sleeve.

FIG. 2B is a view of a compression ring.

FIG. 2C is a partial cross-sectional view of the embodiment of FIG. 1B showing the telescoping handle in an extended position.

FIG. 2D is a view of a snap ring.

FIG. 2E is a cut-away cross-sectional view of the outer sleeve showing the main shank in an unextended position.

It is noted that the drawing figures are not necessarily drawn to scale, but instead are drawn to provide a better understanding of the illustrated features and components thereof. In particular, the location of the numerous components and features are generalized for ease of understanding.

### DETAILED DESCRIPTION OF THE EMBODIMENT

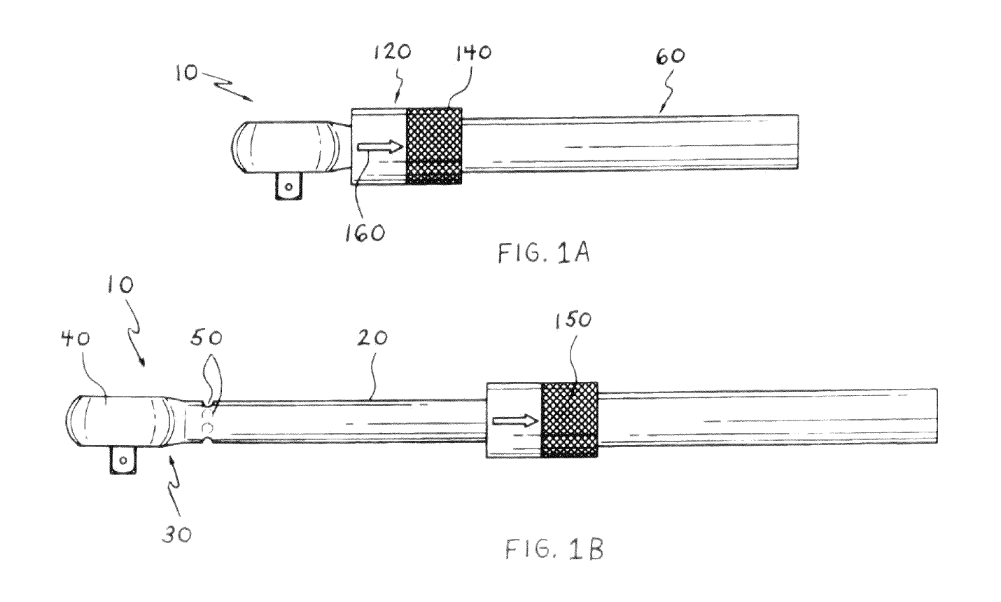

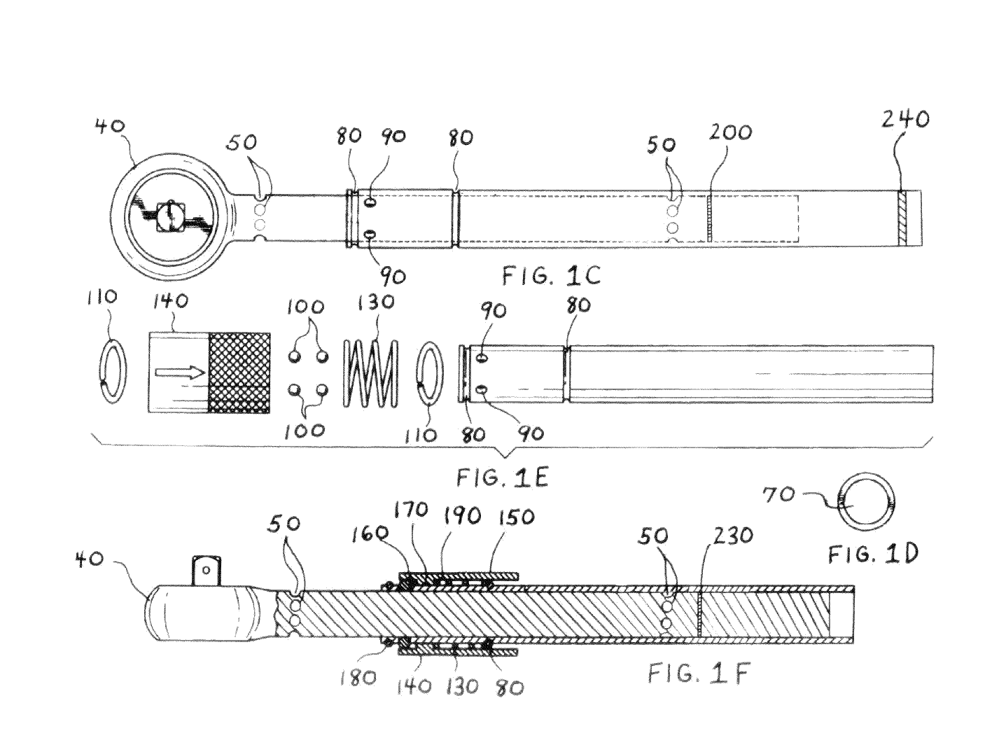

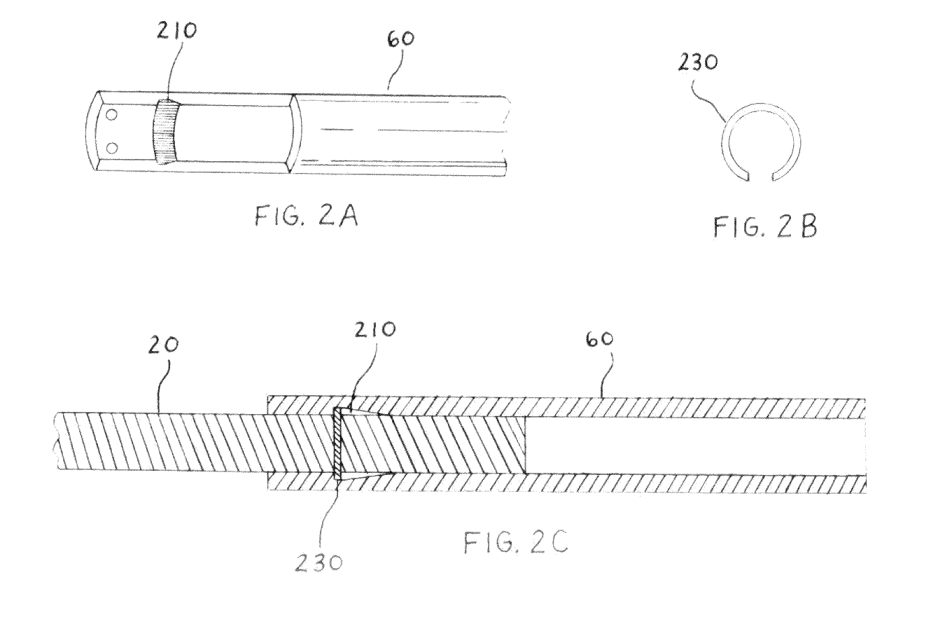

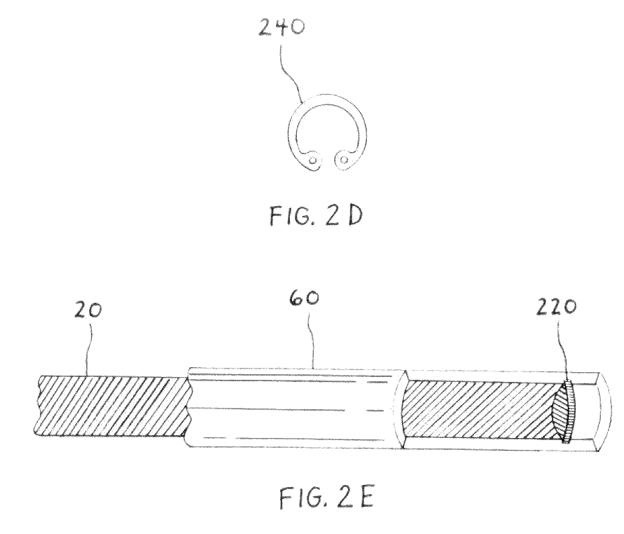

An embodiment of a telescoping handle incorporated with a tool head is disclosed in FIGS. 1A to 2E In accordance with this embodiment, a tool 10 includes a main shank 20 having a tool assembly 30 located at one end. The tool assembly 30 may include a tool head portion 40 such as a ratchet head, or any other suitable tool head. The end of the main shank 20 that has the tool head portion located thereon is defined as the distal end of the main shank 20. The opposing end of the main shank 20 is defined as the proximal end.

The outer circumferential surface of the main shank 20 also includes locking mechanisms in the shape of circular indents 50. As illustrated, two positioned circular locking indents 50 are shown, one near the distal end of the main shank 20 and the other near the proximal end of the main shank 20. The circular locking indents positioned at the distal end of the main shank locks the telescoping handle in the unextended position in FIG. 1A. The circular locking indents positioned at the proximal end of the main shank locks the telescoping handle in the extended position in FIG. 1B.

In this embodiment, as best seen in FIGS. 1C and 1E, the telescoping handle includes an outer sleeve 60 that has distal and proximal ends and a bore 70 running therethrough that is defined by an inner circumferential surface. The outer sleeve 60 includes two axially spaced snap ring retaining circumferential grooves 80 located near the distal end of the outer sleeve 60. The outer sleeve 60 also includes four clearance holes 90 for receiving bearing members 100 therein. Snap or retainer rings 110 are positioned within the grooves 80 in order to retain a locking and release collar assembly 120 on the outer sleeve 60. A spring member 130 is received on the outer sleeve 60 between the proximal snap ring 110 and the locking and release collar assembly 120 in order to bias the annular locking collar towards the distal end of the outer sleeve 60 to be axially locked with respect to the main shank 20.

The locking and release collar assembly 120 may include an annular locking collar 140 having an outer circumferential surface which may include a textured or knurled portion 150 and indicia 160 for indicating the direction of axial movement required to release the locking collar assembly 120. The textured or knurled portion 150 may be formed in any known manner, such as milling. The indicia 160 may be engraved on the collar 140 by tooling or laser engraving, or any other suitable method of marking.

The annular collar 140 further includes distal and proximal inner circumferential surfaces that are separated at distal and proximal right angles by a circumferential bearing engaging surface 170. The distal right angle portion forms a distal snap ring engaging surface 180 for selectively engaging the distal snap ring 110. The proximal right angle portion forms a spring member engaging surface 190 for engaging the spring 130. The function of the collar is apparent, and best shown in FIG. 1F, where the telescoping handle is shown with the outer sleeve 60 in position on the main shank 20 in an unlocked and partially extended position. The bearing members 100, illustrated as four ball bearing members, ride within the clearance holes 90 in engagement with the outer circumferential surface of the main shank 20, and retained within the clearance holes by the annular collar 140

In the unextended and locked position shown in FIG. 1A, the four bearing members 108 are received within four of the eight circular formed indents 50 located near the distal end of the main shank 20 and are retained within the indents 50 via engagement with the bearing member engaging surface 170 of the annular collar 140. The spring member 130 biases the annular collar 140 in this position such that the distal snap ring engaging surface 160 engages the distal snap ring 180.

In order to release the outer sleeve 60 from being axially locked in engagement with the main shank 20, a user moves the annular collar 140 against the biasing force of the spring member 130 towards the proximal end of the outer sleeve 60 As the annular collar 140 is moved away from engagement with the distal snap ring 110, the bearing member engaging surface 170 moves out of engagement with the beating members 100 as shown in FIG. 1F.

Once the bearing member engaging surface 170 no longer engages the bearing members 100, the outer sleeve 60 may be axially moved with respect to the main shank 20. As the outer sleeve 60 is moved, the bearing members 100 follow the outer circumference of the main shank 20 and are raised within the clearance holes 90 above the outer circumference of the outer sleeve 60, and may engage the distal inner circumferential surface of the annular collar 140. When the spring member 130 is fully compressed, the bearing members 100 are still engaged by the distal inner circumferential surface of the annular collar 140 such that they can not be removed from the clearance holes 90.

Once the bearing members 100 are removed from the circular indents 50, the outer sleeve 60 is axially movable and rotationally movable with respect to the main shank 20 until the four bearing members are received within another, or the same, circular indents 50, aid the annular collar 140 is positioned such that the distal snap ring engaging surface 160 engages the distal snap ring 110. In this manner, the outer sleeve 60 can be axially locked in the unextended FIG. 1A and the extended FIG. 1B positions along the main shank 20 that corresponds to each positioned locking circular indents 50.

The indents 50 formed in a circular pattern around the outer circumferential surface of the main shank 20, and the four bearing members 100 serves both the function of locking the outer sleeve 60 from axial movement, and locking the outer sleeve 60 from rotation.

Also, the number of indents formed around the outer circumferential shape of the main shank 2: may be varied. For example, four, eight, sixteen, or any suitable number of indents may be used that would be apparent to a skilled artisan.

In order to maintain the outer sleeve 60 around the main shank 20, a compression ring 230 is provided near the proximal end of the main shank 20. The compression ring 230 is inserted within a machined groove 200 formed around the outer circumferential shape of the main shank 20, near the proximal end. The outer sleeve 60 is machined with a tapered groove 210 within the inner circumferential surface of the outer sleeve 60 and near the distal end, as best seen in FIG. 2A.

When the telescoping handle is in the fully extended position as seen in FIG. 1B, the compression ring 230 is expanded and engaged in the tapered groove 210 within the outer sleeve 60, therefore providing a terminal stop, as best seen in FIG. 2C. Additionally, when the telescoping handle is in the fully extended position FIG. 1B the four bearing members 100 within the four clearance holes 90 are aligned and engage four of the eight circular indents 50, locking the outer sleeve 60 from axial and rotational movement.

In order to lock the telescoping handle in the unextended position FIG. 1A, the four bearing members 100 within the four clearance holes 90 of the outer sleeve 60 need to align with the circular locking indents 50 formed on the distal end of the main shank 20. In order to limit the axial movement of the outer sleeve 20 and align the four bearing members 100 with the circular locking indents 50, a terminal stop is provided so that the proximal end of the main shank 20 makes contact with a snap ring 240 inserted within a machined groove 220 near the proximal end and inner circumferential surface of the outer sleeve 6B. As best seen in FIG. 2E A portion of the outer sleeve 60 may include a textured or knurled portion, or a rubber or plastic grip affixed to the outer sleeve in order to improve gripping and handling of the tool.

The main shank 20, the outer sleeve 60, and the annular collar 140, may be made from any suitable material, for example, tool steel. The snap rings 110, 240, spring member 130 and compression ring 230, may be made from any suitable material, for example, spring steel.

1. A tool having a telescoping handle
said handle having a main shank and an outer sleeve complimentarily sleeved to slidably receive said main shank therein;
said main shank further including indents formed in a circular pattern around its outer circumferential surface;
said outer sleeve comprising a outer collar;
said collar further comprising at least one bearing member internally affixed so as to selectively engage said main shank's said indents so as to permit selective engagement in both a linear and a rotational locking position.
